(19) United States
(12) Patent Application Publication
(10) Pub. No.: US 2001/0002773 A1
(43) Pub. Date: Jun. 7, 2001

(54) Feeder cable

(76) Inventor: Takashi Hyogo, kariya-shi (JP)

Correspondence Address: Kurt E.Richter, Morgan & Finnegan, L.L.P., 345 Park Avenue, New York, NY, 10154, US

(21) Appl. No.: 09/726,360

(22) Filed: Nov. 30, 2000

(30) Foreign Application Priority Data
Dec. 2, 1999 (JP) 11-343644

(51) Int. Cl. H02J 17/00

(52) U.S. Cl. 307/147

(57) ABSTRACT

A feeder cable has a plurality of power lines arranged at equiangular intervals about the center of the feeder cable. The power lines are arranged such that electric currents flow in opposite directions in every two adjacent power lines. A plurality of unshielded signal lines are included in the cable. Each of the signal lines is located between two adjacent power lines. This reduces the influence of noise upon the signal lines and reduces the diameter of the cable.

### BACKGROUND OF THE INVENTION

The present invention relates to a feeder cable suitable for connecting, for example, a charging paddle having built-in communication equipment with a power supply unit.

Generally, there is an induction method for charging batteries in electric vehicles. The induction method is such that the batteries are charged by inductive generated between a pair of coils. In an induction type battery charger, a feeder cable, having a charging paddle at its end, extends from a power supply unit. The charging paddle contains a primary coil for supplying power. Each vehicle is provided with a receptacle having a paddle insertion slot. The receptacle contains a secondary coil for receiving power.

When the charging paddle is inserted to the slot of the receptacle, electricity is supplied from the power supply unit to the primary coil through the feeder cable. Thus, the secondary coil generates an electromotive force under electromagnetic inductive action. The battery in the vehicle is charged based on this electromotive force.

During charging, the charging paddle and the receptacle exchange information necessary for setting charging conditions and the like. However, the charging paddle and the receptacle are not mechanically connected to each other, so that they exchange information by wireless communication. In order to achieve this wireless communication, both the charging paddle and the receptacle are each provided with wireless communication equipment. The wireless communication equipment in the charging paddle is connected through the feeder cable to a controller built in the power supply unit. The controller transmits various kinds of information to the communication equipment in the charging paddle and also stores information received by the communication equipment in the charging paddle.

The feeder cable is provided with a plurality of power lines for feeding power to the primary coil and one or more signal lines for connecting the communication equipment in the charging paddle with the controller in the power supply unit. The electric current flowing through the power lines generates noise that affect signals transmitted through the signal lines. However, if the signal lines are shielded against noise, the feeder cable becomes thick, making handling of the charging paddle more difficult.

### SUMMARY OF THE INVENTION

Accordingly, it is an objective of the present invention to provide a feeder cable that avoids the influence of noise on the signal lines and is relatively small in diameter.

To attain the above-mentioned object, the present invention provides a feeder cable. The feeder cable comprises a plurality of power lines arranged equiangularly about the central axis of the feeder cable. The power lines are arranged such that electric currents that flow in any adjacent two of the power lines flow in opposite directions. A plurality of unshielded signal lines are located. Each of the signal lines is located between two of the power lines that are adjacent.

Other aspects and advantages of the invention will become apparent from the following description, taken in conjunction with the accompanying drawings illustrated by way of examples the principles of the invention.

### BRIEF DESCRIPTION OF THE DRAWINGS

The invention together with the objects and advantages thereof, may best be understood by reference to the following description of the presently preferred embodiments together with the accompanying drawings in which:

FIG. 1 is a plan view, which parts removed, showing the charging paddle of an inductive battery charger according to a first embodiment of the present invention;

FIG. 2 is a cross-sectional view of the feeder cable connected to the charging paddle shown in FIG. 1;

FIG. 3 is a schematic drawing showing the state where the power lines are connected to the primary coil;

FIG. 4 is a perspective view the charging paddle shown in FIG. 1 being used;

FIG. 5(a) is a cross-sectional view of the feeder cable according to a second embodiment of the present invention;

FIG. 5(b) is a cross-sectional view of the feeder cable according to a third embodiment of the present invention;

FIG. 6(a) is a cross-sectional view of the feeder cable according to a fourth embodiment of the present invention;

FIG. 6(b) is a cross-sectional view of the feeder cable according to a fifth embodiment of the present invention; and

FIG. 7 is a cross-sectional view of the feeder cable according to a sixth embodiment of the present invention.

### DETAILED DESCRIPTION OF THE PREFERRED EMBODIMENTS

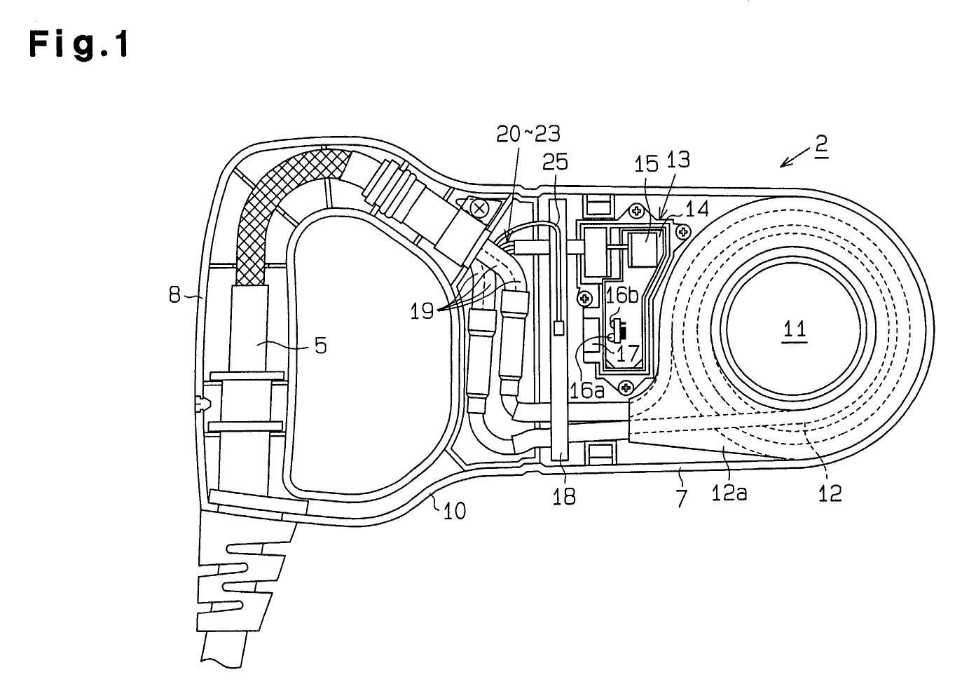

A first embodiment of the present invention will be described below referring to FIGS. 1 to 4.

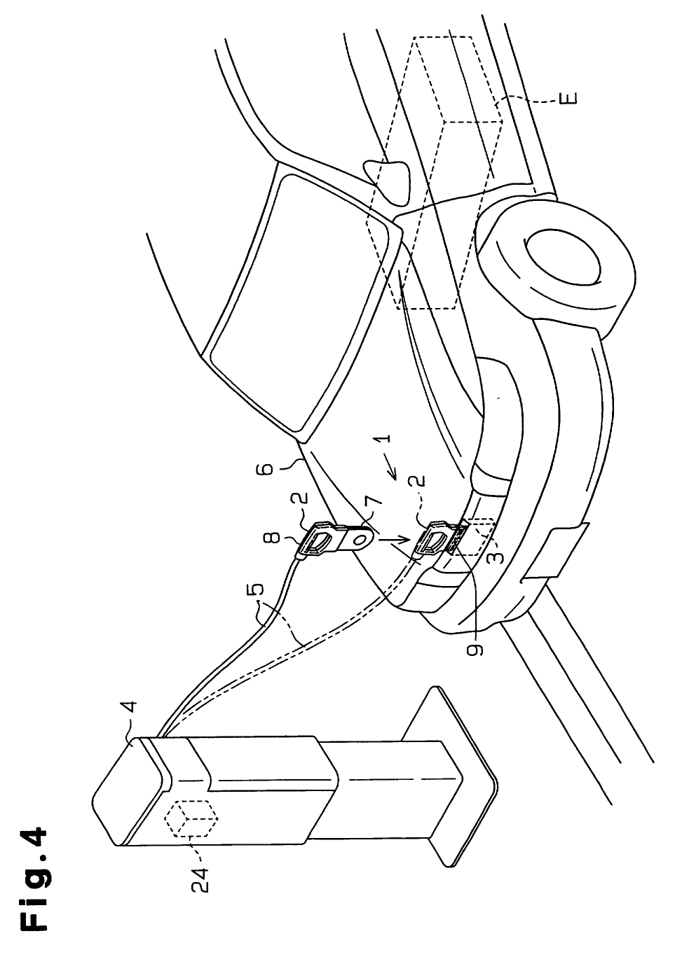

FIG. 4 shows an inductive battery charger 1. A charging paddle 2 is attached to the end of a feeder cable 5 extended from a power supply unit 4. An electric vehicle 6 has a receptacle 3 in a predetermined position (in front of the bonnet in FIG. 4). The charging paddle 2 has a head 7 and a grip 8. The head 7 can be inserted into and removed from a slot 9 of the receptacle 3.

Next, the charging paddle 2 will be described. FIG. 1 is a plan view showing the state where part of a case 10 of the charging paddle 2 is removed. The case 10 houses a cylindrical ferrite core 11 and a primary coil 12 wound around the ferrite core 11. The primary coil 12 is covered with insulating material. The case 10 houses communication equipment 13, which is an infrared data communication system in this embodiment. The case 10 is made of infrared-transmitting resin.

The communication equipment 13 is provided with a communication circuit 15, an infrared light-emitting element 16a and an infrared light-receiving element 16b, which are mounted on a substrate 14. The central axis of the light-emitting element 16a and that of the light-receiving element 16b are parallel to the substrate 14. Although not shown, the receptacle 3 is also provided with a light-emitting element and a light-receiving element. The communication equipment 13 exchanges information with the communication equipment in the receptacle 3 through the light-emitting element 16a and the light-receiving element 16b.

A prism 17 is located on the substrate 14 in a position where it opposes the light-emitting element 16a and the light-receiving element 16b. The prism 17 causes the infrared light from the light-emitting element 16a to be transmitted from both sides of the paddle 2. The prism 17 also leads the infrared radiation coming in from either side of the paddle 2 to the light-receiving element 16b. This enables infrared communication when the charging paddle 2 is inserted in the receptacle 3 regardless of whether it faces the front side or the rear side of the receptacle 3.

An antenna 18 for transmitting and receiving radio waves is contained in the case 10. This enables the charging paddle 2 to carry out both radio wireless communication and infrared wireless communication.

As shown in FIGS. 1 to 4, the primary coil 12 is connected to the power supply unit 4 through four power lines 19. The communication equipment 13 is connected to a controller 24 in the power supply unit 4 through four signal lines 20 to 23. The antenna 18 is connected to the controller 24 through a communication line 25. The lines 19 to 23 and 25 are bundled into a single feeder cable 5. The controller 24 receives information about the vehicle including the voltage of a battery E in the electric vehicle 6 and the fluid temperature of the battery E through the communication equipment 13 or the antenna 18. The controller 24 then controls the charging operation depending on the information.

As shown in FIG. 1, the distal end of the feeder cable 5 is located in the grip 8. The power lines 19 that extend from the feeder cable 5 are connected to the primary coil 12 in the case 10. As shown in FIG. 3, there are two pairs of power lines 19, and the direction of electric current flowing through the two lines of one pair is opposite to that of the other pair. The two pairs of power lines 19, are connected to the ends of the primary coil 12, respectively.

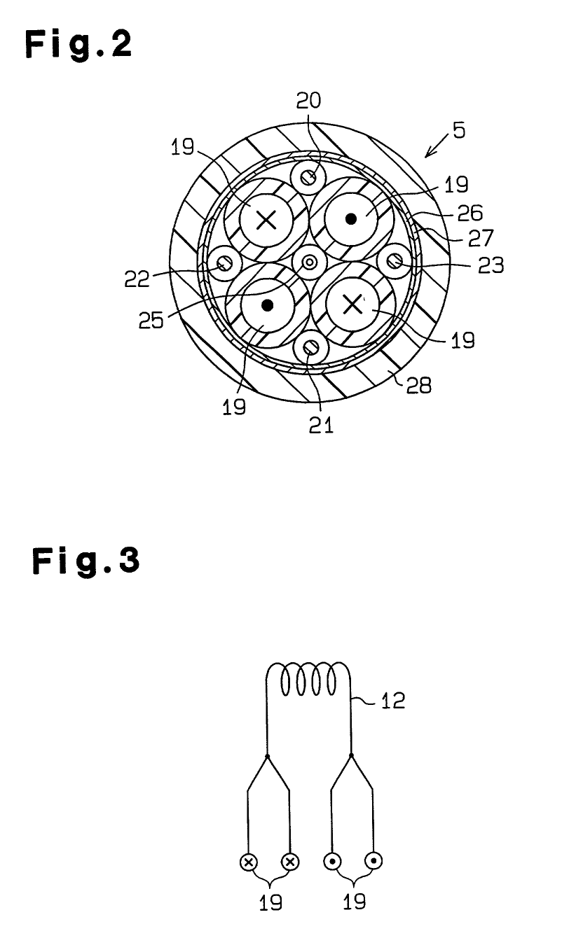

Next, the feeder cable 5 will be described specifically. As shown in FIG. 2, the four power lines 19 are arranged at equiangular intervals on a first circle drawn about the central axis of the feeder cable 5. The power lines 19 are arranged such that the direction of electric current flow is opposite in every two adjacent power lines 19. The four signal lines 20 to 23 are arranged at equiangular intervals on a second circle drawn about the central axis of the feeder cable 5 and are outward of the first circle. Adjacent power lines 19 are located in contact with each other. The signal lines 20 to 23 are located in between and in contact with each pair of adjacent power lines 19. The power source signal line 20 (e.g., 5 V) is located 180 degrees from the grounding signal line 21 (zero volts). The transmitting signal line 22 is located 180 degrees from the receiving signal line 23. The power lines 19 and the signal lines 20 to 23 are all insulated but are not shielded.

The communication line 25 is positioned substantially at the center of the feeder cable 5 and is surrounded by the power lines 19. The communication line 25 is a shielded coaxial cable. The power lines 19 and the signal lines 20 to 23 are twisted. In other words, the power lines 19 and the signal lines 20 to 23 extend helically in the longitudinal direction. The power lines 19 and the signal lines 20 to 23 are covered on the outside with a primary shield 26, a secondary shield 27 and a sheath 28. Gaps between the lines and between the lines and the primary shield 26 are filled with a filler (not shown).

When charging the vehicle, an operator first inserts the charging paddle 2 into the receptacle 3, as indicated by the broken line in FIG. 4. In this state, the ferrite core 11 and primary coil 12 in the charging paddle 2 oppose the core and the secondary coil (which are not shown) of the receptacle 3, respectively, without making contact. An alternating electric current is then supplied from the power supply unit 4 to the primary coil 12 through the power lines 19 in the feeder cable 5. This causes the secondary coil in the receptacle 3 to generate an electromotive force under the electromagnetic inductive effect. The battery E of the vehicle 6 is charged based on this electromotive force under the electromagnetic inductive action. The power supply unit 4 converts the voltage and frequency of the commercial alternating current into an alternating current having a voltage of several hundreds of V and a frequency of several hundreds of kHz and supplies the latter to the primary coil 12 through the feeder cable 5. The level of electric power is controlled by the controller 24 according to the information concerning the vehicle battery E received through the communication equipment 13 or the antenna 18.

Before starting charging and during charging, the controller 24 exchanges information with the receptacle 3 through the communication equipment 13 or the antenna 18. The signal lines 20 to 23 are positioned in the vicinity of the power lines 19 and are not shielded to avoid increasing in the diameter of the feeder cable 5. This causes the power lines 19 to generate noise when conducting high voltage current.

However, the directions of the electric currents flowing through every pair of adjacent power lines 19 are opposite to each other. Thus, the noise generated from one power line 19 and those from the other offset each other. Further, since the signal lines 20 to 23 are each located in an intermediate position between two adjacent power lines 19, the signal lines 20 to 23 are not substantially influenced by the noise. This achieves clear communication between the controller 24 and the communication equipment 13.

This embodiment has the following effects.

Since the signal lines 20 to 23 are not affected by noise, they need not be shielded. This allows the diameter of the feeder cable 5 to remain relatively small.

The number of the power lines 19 and that of the signal lines 20 to 23 are the same, and the signal lines 20 to 23 are each located between adjacent two power lines 19. Thus, the signal lines 20 to 23 are arranged neatly and are well balanced in the feeder cable 5. Even if the lines 19 to 23 are twisted, no excessive force is likely to act upon them, which facilitates manufacture of the feeder cables 5.

The shielded communication line 25 for radio communication is positioned at the center of the feeder cable 5. This enables radio communication through the antenna 18 in addition to the infrared communication.

The invention is not to limit to the embodiment described above and can be modified, for example, as follows:

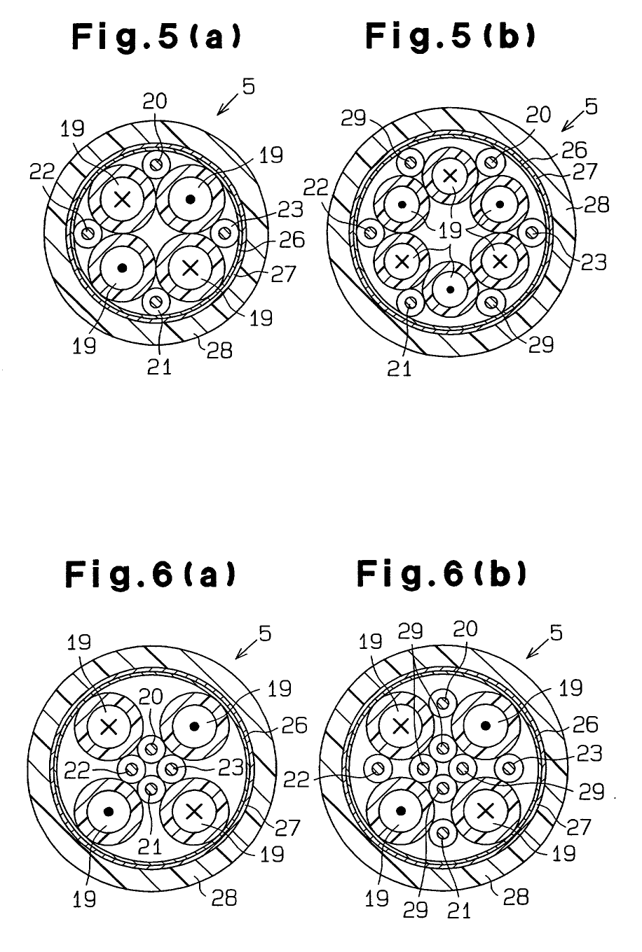

In a second embodiment shown in FIG. 5(a), the communication line 25 for radiowave communication is omitted.

The number of power lines 19 is not limited to four and may be, for example, six or eight. For example, in a third embodiment shown in FIG. 5(b), six power lines 19 are each arranged in contact with adjacent lines. Four signal lines 20 to 23 are arranged outward the circle defined by the centers of the power lines 19. Electric currents of adjacent lines flow in opposite directions.

While four signal lines 20 to 23 are each located between adjacent power lines 19, another two signal lines 29 can each be located between adjacent two power lines 19 compared with the feeder cable 5 shown in FIG. 5(a). These signal lines 29 can be used for purposes other than communication. For example, a sensor (e.g., temperature sensor) is located in the charging paddle 2, and detection signals from the sensor can be fed to the controller 24.

In the case where the communication line 25 for radio communication is absent, the signal lines 20 to 23 may be located inward of the power lines 19 to a contact with each other in a fourth embodiment as shown in FIG. 6(a). In this case, another four signal lines 29 may each be located between adjacent two power lines 19 in a fifth embodiment as shown in FIG. 6(b).

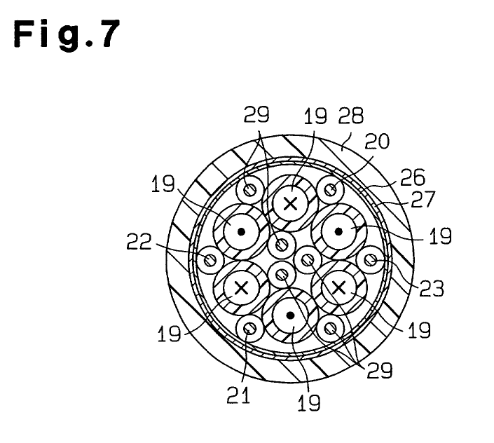

In a sixth embodiment shown in FIG. 7, another three signal lines are added to the cable 5 shown in FIG. 5(b). The additional three signal lines are located in the center area surrounded by the six power lines 19. Since adjacent power lines 19 contact one another, the lines 19 to 23 and 29 can be twisted easily.

The communication method is not limited to infrared communication, but other wireless communication methods may be employed.

The present invention may be applied to feeder cables of inductive battery chargers not only for vehicles but also for other purposes.

It should be apparent to those skilled in the art that the present invention may be embodied in many other specific forms without departing from the spirit or scope of the invention. Particularly, it should be understood that the invention may be embodied in the following forms.

Therefore, the present examples and embodiments are to be considered as illustrative and not restrictive, and the invention is not to be limited to the details given herein, but may be modified within the scope of the appended claims.

What is claimed is:

1. A feeder cable comprising:
a plurality of power lines arranged equiangularly about the central axis of the feeder cable, wherein the power lines are arranged such that electric currents that flow in any adjacent two of the power lines flow in opposite directions; and
a plurality of unshielded signal lines, wherein each of the signal lines is located between two of the power lines that are adjacent.

2. The feeder cable according to claim 1, wherein the number of the power lines and the number of the signal lines are equal.

3. The feeder cable according to claim 1, wherein the centers of signal lines are arranged outward of a circle defined by the centers of the power lines.

4. The feeder cable according to claim 1, wherein the centers of signal lines are arranged inward of a circle defined by the centers of the power lines.

5. The feeder cable according to claim 1, wherein there are at least four power lines, wherein the signal lines are for infrared communication.

6. The feeder cable according to claim 3, wherein a shielded communication line for radio communication is located at the center of the feeder cable.

7. The feeder cable according to claim 1, wherein the feeder cable connects a charge paddle having a communication apparatus to a stationary power supplying apparatus.

8. The feeder cable according to claim 1, wherein the power lines are located in contact with each other.

9. The feeder cable according to claim 1, wherein the signal lines are located in contact with two of the power lines.

10. A feeder cable for connecting a charge paddle, which includes a communication apparatus, to a power supplying apparatus, the feeder cable comprising:
a plurality of power lines arranged equiangularly about the central axis of the feeder cable, wherein the power lines are arranged such that electric currents that flow in any adjacent two of the power lines flow in opposite directions; and
a plurality of unshielded signal lines, wherein each of the signal lines is located between two of the power lines that are adjacent.

11. A feeder cable for connecting a charge paddle, which includes a communication apparatus, to a power supplying apparatus, the feeder cable comprising:
a plurality of power lines arranged equiangularly about the central axis of the feeder cable, wherein the power lines are arranged such that electric currents that flow in any adjacent two of the power lines flow in opposite directions; and
a plurality of unshielded signal lines, wherein each of the signal lines is located between two of the power lines that are adjacent to offset noise generated by power lines.
